(19) United States
(12) Patent Application Publication
(10) Pub. No.: US 2015/0250107 A1
(43) Pub. Date: Sep. 10, 2015

(54) PLANTER WITH SIDE WALL THAT ALLOWS FOR DIRECT PLACEMENT OF WATER IN THE BASE CONTAINER

(71) Applicant: Missry Associates Inc., Dunellen, NJ (US)

(72) Inventors: Glen D. JOSEPH, New City, NY (US); Morris MOSKOWITZ, Monsey, NY (US)

(21) Appl. No.: 14/643,761

(22) Filed: Mar. 10, 2015

Related U.S. Application Data
(60) Provisional application No. 61/967,115, filed on Mar. 10, 2014.

(51) Int. Cl. A01G 9/02; A01G 27/00

(52) U.S. Cl. CPC A01G 9/02; A01G 27/005

(57) ABSTRACT

The present invention provides a planter or flower pot having a base member having at least one indentation in a side wall wherein said indentation is sized to allow a watering device having a spout to deliver water to at least a portion of a side wall that extends upwardly from the bottom of the flower pot and is wide enough so that water delivered to the side wall will flow downwardly along the sidewall to the bottom of the flower pot and into the space defined by the base member or saucer.

This application claims the benefit of Provisional Application Ser. No. 61/967,115, filed Mar. 10, 2014.

### FIELD OF THE INVENTION

This invention relates generally to planters that are intended for use with flower pots having a base container or a saucer for storing a reservoir of water.

### BACKGROUND OF THE INVENTION

U.S. Pat. No. 5,638,638 discloses a flower pot that has a base container or saucer that are provided with complimentary structures in the flower pot and in the base member that facilitate the addition of water to the base container by making the base member accessible to water that is delivered through the spout of a conventional watering can. This is done to provide water to the plant in the flower pot by capillary action that causes water in the base member to pass upwardly through holes in the bottom of the pot which are submerged below the level of water in the container.

The prior art flower pot was provided with a concave depression that was formed on a lower edge of the side wall of the flower pot in such a manner the concave depression tapers off in both the upward and downward direction. The base member was formed so that it has a protruding lip formed in a side wall of the base member that is positionable to be in register with the concave depression on the side wall of the flower pot. If water is added from a watering can, directly to the base member, the water will tend to flow from the watering can spout before it is positioned above the protruding lip and some water will be spilled before the spout is properly aligned with the protruding lip of the base member and will spill on the floor.

### SUMMARY OF THE INVENTION

The present invention provides a planter or flower pot having a base member having at least one indentation in a side wall wherein said indentation is sized to allow a watering device having a spout to deliver water to at least a portion of a side wall that extends upwardly from the bottom of the flower pot and is wide enough so that water delivered to the side wall will flow downwardly along the sidewall to the bottom of the flower pot and into the space defined by the base member or saucer. Alternatively, the flower pot may be sized so that the flower pot has a diameter less than the diameter of the base member so that water may be delivered to the side of a flower pot so that the water will flow downwardly into a base member that may optionally have a base member with an outwardly flared upper rim. The present design reduces the spillage of water that occurs as the spout of a water can is lowered into the position for delivering water to the side of a flower pot.

### BRIEF DESCRIPTION OF THE DRAWINGS

FIG. 1 is a side elevational view of the flower pot with the base member detached.

FIG. 2 is a cross-section of an alternate embodiment of the invention with a lower pot sized so that the diameter is less than the diameter of the base member.

### DETAILED DESCRIPTION OF THE INVENTION

To deliver the water to the base member by pouring water against the side wall of a planter, it is preferred to provide an indentation where the indentation is wide enough to contain a flow of water downwardly towards the base of the flower pot and is preferably about 0.75″ to about 3″ wide and has a height from about 4″ to about 9″, provided that the height of the indentation does not exceed about 75% of the total height of the side wall wherein said planter has a width a an average depth of which is a depth that is about equal to the thickness of the side wall to about 0.75″.

The profile of the indentation from the perspective of height and width may be rectangular with round or square corners or it may have an upper top portion that is curved, notched or shaped in any configuration such as a series of one or more rounded arches.

The indentation should have a slope that is designed so that when water is poured against the indentation, the slope will not drip off of side wall of the flower pot before the water reaches the bottom of the side wall. Generally, the slope of the indentation will be 3° to 15° measured against the vertical axis of the planter.

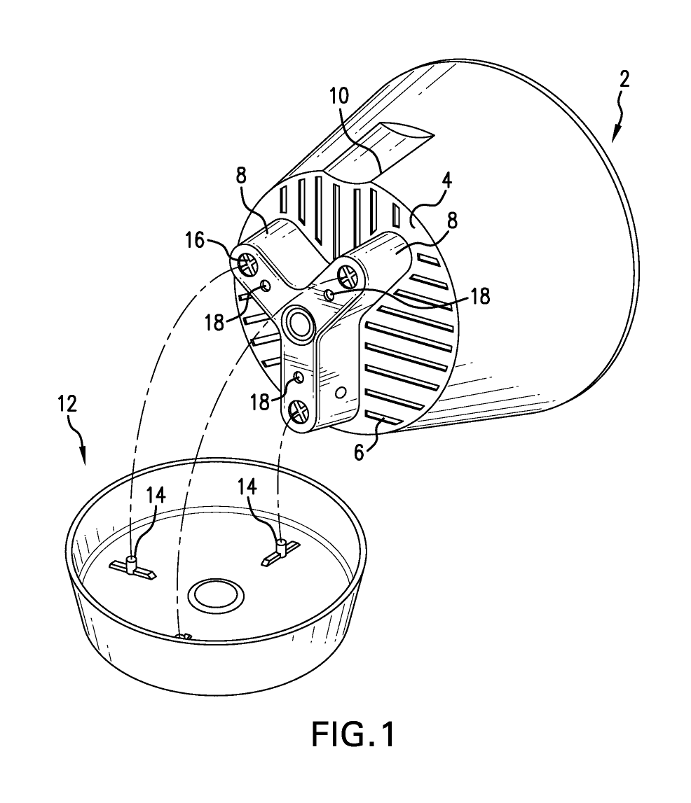

As best shown in FIG. 1, a frustoconical flower pot 2 having a flower pot base 4 with holes or slots 6 of any shape that provide aeration where the base is connected to one or more integrated legs that communicate with the main part of the flower pot. Preferably, three integrated legs 8 arranged in the shape of a Y are provided. The legs 8 are hollow and are in communication with the interior of the flower pot through holes 20 in order to accommodate the roots of a plants and to allow water to flow into the space where soil and plant roots are disposed.

An indentation 10 is provided in the side wall of the flower pot which is adapted to receive a flow of water that is delivered from the spout of a watering can. The indentation is sized as described above.

A base member 12 is provided which will function as a reservoir for water that is delivered by capillary action through slots 6 when the flower pot base is positioned in the base member 12. Supports 14 are positioned in base member 12 to receive crucible openings 16 to engage the base member 12 with the flower pot 2.

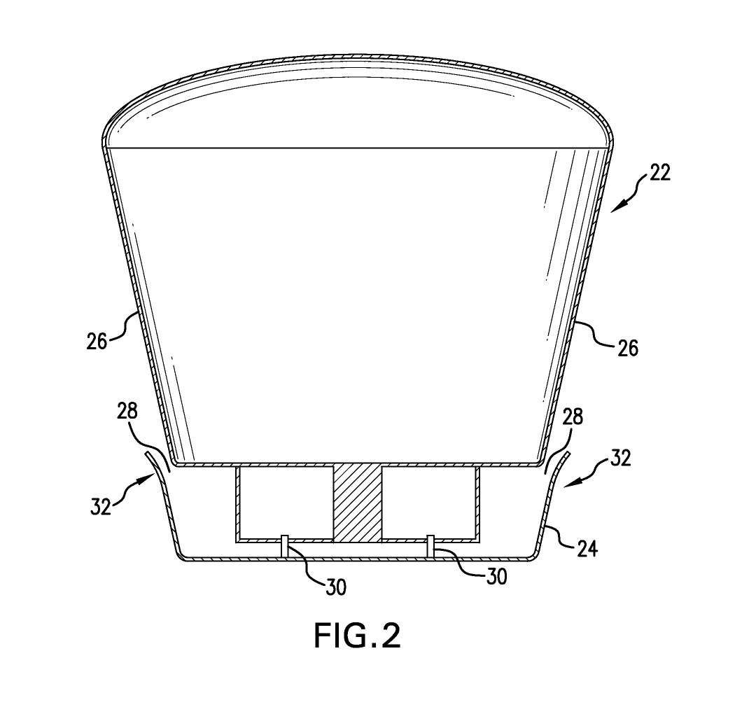

As shown in FIG. 2, the flower pot 22 may be made with a diameter that is less than the diameter of the base member 24 at the point where the wall of the flower pot is adjacent to the wall of the base member when the flower pot is fully inserted into the base member so that when water is poured against the side wall 26, the water will run down the side wall 26 and through opening 28 into the base member. Holes are provided in the bottom of flower pot 22 to allow water to flow upwardly by capillary action to water the plant in the flower pot. The side wall 32 of base member 24 is preferably slightly flared outwardly to prevent spillage of water.

1. A planter comprising a pot and a base member having at least one indentation in a side wall wherein said indentation is sized to allow a watering device having a spout to deliver water to at least a portion of a side wall that extends upwardly from the bottom of the flower pot and is wide enough so that water delivered to the side wall will flow downwardly along the sidewall to the bottom of the flower pot and into the space defined by the base member.

2. A planter comprising a pot and a base member as defined in claim 1 where said pot comprises one or more indentations in a side wall wherein said indentation is from about 0.75″ to about 3″ wide and from about 4″ to about 9″ in height, provided that the height of the indentation does not exceed about 75% of the total height of the side wall, wherein said planter has a with a an average depth of which is a depth that is about equal to the thickness of the side wall” to about 0.75″.

2. The planter comprising a pot and a base member defined in claim 1 wherein the indentation is said side wall is sloped so that the indentation is angled inwardly towards the interior of the planter.

3. The planter comprising a pot and a base member defined by claim 2 wherein the slope is from 3° to 15° measured against the vertical axis of the planter.

4. The planter comprising a pot and a base member defined in claim 1 wherein said planter has a frustoconical shape.

5. The planter comprising a pot and a base member defined in claim 1 wherein said planter has a plurality of flat sides that are joined at their edges.

6. The planter comprising a pot and a base member as defined in claim 1 wherein the bottom is provided with legs that prevent the bottom of the flower pot from touching the floor of the base member.

7. A planter comprising a pot and a base member where the pot is made with a diameter, measured near the base member when the flower pot is fully disposed in the base member that is less than the diameter of the base member so that when water is poured against the side wall, the water will run down the side wall through an opening formed by a space between the pot and the base member.
